(19) United States
(12) Patent Application Publication
(10) Pub. No.: US 2025/0369807 A1
(43) Pub. Date: Dec. 4, 2025

(54) TEMPERATURE ESTIMATION WITHIN AN ELECTRONIC DEVICE

(71) Applicant: Apple Inc., Cupertino, CA (US)

(72) Inventors: Srikanth BALASUBRAMANIAN, Los Altos, CA (US); Matthias Knoth, Chapel Hill, NC (US); Yizhang Yang, Sunnyvale, CA (US); Toshinari Takayanagi, San Jose, CA (US)

(73) Assignee: Apple Inc., Cupertino, CA (US)

(21) Appl. No.: 18/678,785

(22) Filed: May 30, 2024

(51) Int. Cl. G01K 7/20; G01K 1/024

(52) U.S. Cl. CPC G01K 7/20; G01K 1/024

(57) ABSTRACT

Systems, methods, and apparatuses disclosed herein can develop a temperature profile having a level of detail, granularity, resolution, or the like that exceeds a temperature profile that is developed solely from readings of one or more temperature sensors alone. The temperature profile developed by these systems, methods, and apparatuses beneficially includes more precise temperature values allowing for a more detailed analysis of the temperature of these systems, methods, and apparatuses. These systems, methods, and apparatuses can estimate, or interpolate, temperature values between the readings of the one or more temperature sensors to provide the more precise temperature values that have smaller intervals between these temperature values. These more precise temperature values can advantageously capture transient variations in the temperature of these systems, methods, and apparatuses occurring between the readings of the one or more temperature sensors which would otherwise be hidden if the temperature profile were developed solely from these readings alone.

### BACKGROUND

It can be advantageous to develop a conventional temperature profile for a conventional electronic device. The conventional temperature profile thermal profile can be developed by reading one or more temperature values for the conventional electronic device from one or more temperature sensors within the conventional electronic device. The conventional temperature profile can include one or more temperature thresholds for the conventional electronic device. These temperature thresholds represent one or more safe operating temperatures set, for example, by a manufacturer of the conventional electronic device, whereby performance degradation, system instability, or even permanent damage can occur if these temperature thresholds are exceeded. Often times, the one or more temperature thresholds can include one or more thermal guard bands that represent one or more safety margins, or allowances, that are included in the conventional temperature profile of the conventional electronic device to ensure that the conventional electronic device operates safely under various operating conditions. Often times, the temperature of the conventional electronic device can vary between the readings of the one or more temperature sensors which are hidden from the temperature profile developed solely from these readings alone. As a result, the one or more thermal guard bands are conventionally set to accommodate for these transient variations in the temperature of the conventional electronic device occurring between the readings of the one or more temperature sensors. Often times, these transient variations in the temperature are not very frequent in their occurrence, but must be accounted to ensure that the conventional electronic device operates safely.

### SUMMARY OF DISCLOSURE

Some embodiments of this disclosure describe an electronic device including a temperature measurement system, a temperature interpolation system, and a performance manager. The temperature measurement system samples a raw temperature sensor reading provided by a temperature sensor at a temperature sampling rate to provide actual temperature values. The temperature interpolation system samples a temperature prediction that has been predicted by the electronic device at a temperature interpolation rate to provide an interpolated temperature values, the temperature interpolation rate being greater than the temperature sampling rate. The performance manager combines the actual temperature values at the temperature sampling rate and the interpolated temperature values at the temperature interpolation rate to estimate a temperatures of the electronic device at the temperature interpolation rate, compares the temperatures of the electronic device at the temperature interpolation rate to a temperature threshold, and adjusts performance of the electronic device when one or more of the temperatures of the electronic device at the temperature interpolation rate is greater than the temperature threshold.

In some embodiments, the temperature interpolation system can predict the interpolated temperature values at the temperature interpolation rate based upon power needed to execute a workload. In these embodiments, the temperature interpolation system can develop a thermal model of the electronic device to model transient thermal behavior of the electronic device and simulate the thermal model of the electronic device in accordance with the power needed to execute the workload to provide the temperature prediction. In these embodiments, the thermal model of the electronic device can include a Foster resistance capacitance ladder having a thermal time constants, the thermal time constants being less than a percentage of the temperature interpolation rate.

In some embodiments, the performance manager can load a first actual temperature value from among the actual temperature values received at a first duration in time to provide a first temperature of the electronic device at the first duration in time and combine a second interpolated temperature values from among the interpolated temperature values received at a second durations in time and the first actual temperature value to provide a second temperatures of the electronic device at the second durations in time. In these embodiments, the performance manager include an accumulator. In these embodiments, the performance manager can load the first actual temperature value into the accumulator and reset the accumulator upon receiving a third actual temperature value from among the actual temperature values received at a third duration in time.

Some embodiments of this disclosure describe a method for estimating temperatures of an electronic device. The method includes sampling, at a temperature sampling rate, a raw temperature sensor reading provided by a temperature sensor to provide actual temperature values; sampling, at a temperature interpolation rate, a temperature prediction that has been predicted by the electronic device to provide an interpolated temperature values, the temperature interpolation rate being greater than the temperature sampling rate; and combining, by the electronic device, the actual temperature values at the temperature sampling rate and the interpolated temperature values at the temperature interpolation rate to estimate the temperatures of the electronic device at the temperature interpolation rate.

In some embodiments, the method can further include predicting the interpolated temperature values at the temperature interpolation rate based upon power needed to execute a workload. In these embodiments, the predicting can include developing a thermal model of the electronic device to model transient thermal behavior of the electronic device and simulating the thermal model of the electronic device in accordance with the power needed to execute a workload to provide the temperature prediction. In these embodiments, the thermal model of the electronic device can include a Foster resistance capacitance ladder having a thermal time constants, the thermal time constants being less than a percentage of the temperature interpolation rate.

In some embodiments, the method can further include accessing workload data that is indicative of the workload waiting to be executed by the electronic device, the workload being performed by the electronic device, or the workload completed by the electronic device, and evaluating one or more performance metrics in accordance with the workload data to determine the power needed to execute the workload.

In some embodiments, the combining can include loading a first actual temperature value from among the actual temperature values received at a first duration in time to provide a first temperature of the electronic device at the first duration in time and combining a second interpolated temperature values from among the interpolated temperature values received at a second durations in time and the first actual temperature value to provide a second temperatures of the electronic device at the second durations in time. In these embodiments, the loading can include loading the first actual temperature value into an accumulator. In these embodiments, the method can further include resetting the accumulator upon receiving a third actual temperature value from among the actual temperature values received at a third duration in time.

Some embodiments of this disclosure describe an electronic device having a memory and a processor. The memory can store instructions. The processor can execute the instructions stored in the memory, the instructions, when executed by the processor, configuring the processor to: sample a raw temperature sensor reading provided by a temperature sensor at a temperature sampling rate to provide actual temperature values, sample a temperature prediction that has been predicted by the electronic device at a temperature interpolation rate to provide an interpolated temperature values, the temperature interpolation rate being greater than the temperature sampling rate, and combine the actual temperature values at the temperature sampling rate and the interpolated temperature values at the temperature interpolation rate to estimate a temperatures of the electronic device at the temperature interpolation rate.

In some embodiments, the instructions, when executed by the processor, further configure the processor to predict the interpolated temperature values at the temperature interpolation rate based upon power needed to execute a workload. In these embodiments, the instructions, when executed by the processor, further configure the processor to develop a thermal model of the electronic device to model transient thermal behavior of the electronic device and simulate the thermal model of the electronic device in accordance with the power needed to execute a workload to provide the temperature prediction. In these embodiments, the thermal model of the electronic device can include a Foster resistance capacitance ladder having a thermal time constants, the thermal time constants being less than a percentage of the temperature interpolation rate.

In some embodiments, the instructions, when executed by the processor, further configure the processor to access workload data that is indicative of the workload waiting to be executed by the electronic device, the workload being performed by the electronic device, or the workload completed by the electronic device and evaluate one or more performance metrics in accordance with the workload data to determine the power needed to execute the workload.

In some embodiments, the instructions, when executed by the processor, configure the processor to load a first actual temperature value from among the actual temperature values received at a first duration in time to provide a first temperature of the electronic device at the first duration in time and combine a second interpolated temperature values from among the interpolated temperature values received at a second durations in time and the first actual temperature value to provide a second temperatures of the electronic device at the second durations in time. In these embodiments, the instructions, when executed by the processor, further configure the processor to load the first actual temperature value into an accumulator and reset the accumulator upon receiving a third actual temperature value from among the actual temperature values received at a third duration in time.

This Summary of Disclosure is provided merely for illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the disclosure and, together with the description, further serve to explain the principles of the disclosure and enable a person of skill in the relevant art(s) to make and use the disclosure.

FIG. 1 graphically illustrates an exemplary electronic device in accordance with various embodiments of the present disclosure.

FIG. 2 graphically illustrates a first exemplary operation of the exemplary electronic device in accordance with various embodiments of the present disclosure.

FIG. 3 illustrates a flowchart of a second exemplary operation of the exemplary electronic device in accordance with various embodiments of the present disclosure.

FIG. 4 graphically illustrates an exemplary thermal predictor that can be implemented within the exemplary electronic device in accordance with various embodiments of the present disclosure.

FIG. 5 illustrates a block diagram of an exemplary computer system that can be used to implement the exemplary electronic device in accordance with various embodiments of the present disclosure.

The disclosure is described with reference to the accompanying drawings. In the drawings, like reference numbers can indicate identical or functionally similar elements. Additionally, generally, the left-most digit(s) of a reference number identifies the drawing in which the reference number first appears.

### DETAILED DESCRIPTION

### Overview

Systems, methods, and apparatuses disclosed herein can develop a temperature profile having a level of detail, granularity, resolution, or the like that exceeds a temperature profile that is developed solely from readings of one or more temperature sensors alone. The temperature profile developed by these systems, methods, and apparatuses beneficially includes more precise temperature values allowing for a more detailed analysis of the temperature of these systems, methods, and apparatuses. These systems, methods, and apparatuses can estimate, or interpolate, temperature values between the readings of the one or more temperature sensors to provide the more precise temperature values that have smaller intervals between these temperature values. These more precise temperature values can advantageously capture transient variations in the temperature of these systems, methods, and apparatuses occurring between the readings of the one or more temperature sensors which would otherwise be hidden if the temperature profile were developed solely from these readings alone.

### Exemplary Electronic Device

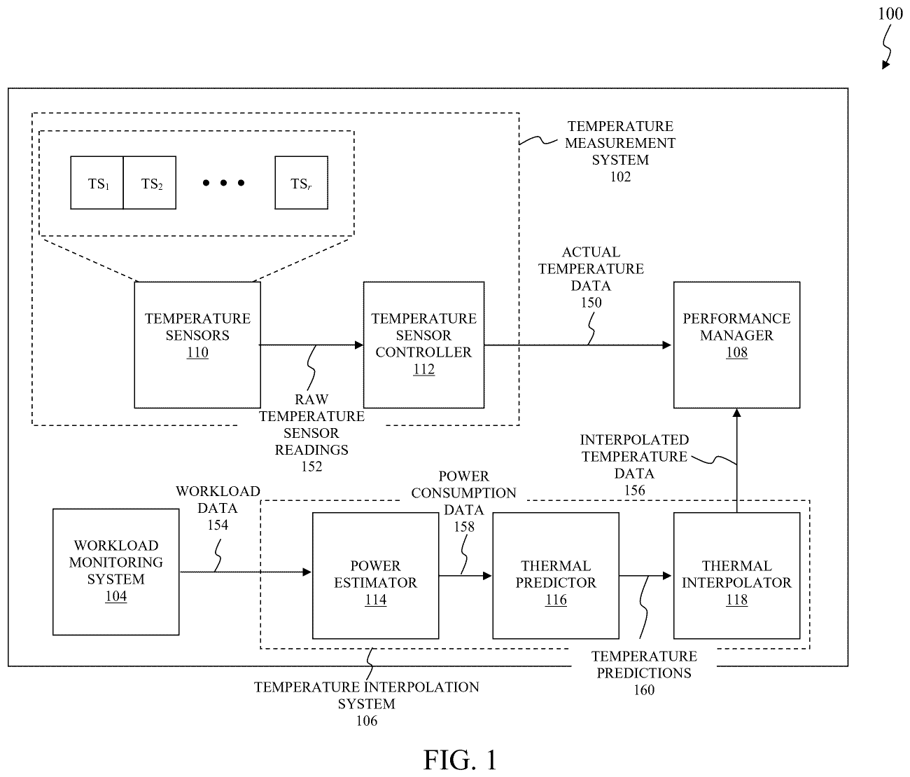

FIG. 1 graphically illustrates an exemplary electronic device in accordance with various embodiments of the present disclosure. In the exemplary embodiment illustrated in FIG. 1, an electronic device 100 can develop a temperature profile having a level of detail, granularity, resolution, or the like that exceeds a temperature profile that is developed solely from readings of one or more temperature sensors alone. In some embodiments, the electronic device 100 can represent one or more integrated circuits (ICs) that are formed onto a semiconductor substrate, such as a thin slice of a silicon crystal to provide an example. In these embodiments, the one or more integrated circuits can include more semiconductor devices and/or passive components than as illustrated in FIG. 1. As to be described in further detail below, the temperature profile developed by the electronic device 100 beneficially includes more precise temperature values allowing for a more detailed analysis of the temperature of the electronic device 100. In some embodiments, the electronic device 100 can estimate, or interpolate, temperature values between the readings of the one or more temperature sensors to provide the more precise temperature values that have smaller intervals between these temperature values. In these embodiments, these more precise temperature values can advantageously capture transient variations in the temperature of the electronic device 100 occurring between the readings of the one or more temperature sensors which would otherwise be hidden if the temperature profile were developed solely from these readings alone. As illustrated in FIG. 1, the electronic device 100 can include a temperature measurement system 102, a workload monitoring system 104, a temperature interpolation system 106, and a performance manager 108. In some embodiments, the temperature measurement system 102, the workload monitoring system 104, the temperature interpolation system 106, the performance manager 108, and/or portions thereof can be implemented in hardware, software, and/or any combination thereof. Those skilled in the relevant art(s) will recognize that the software may be described herein as performing certain actions. However, it should be appreciated that such descriptions are merely for convenience and that such actions in fact result from one or more electrical, mechanical, and/or electro-mechanical devices, such as one or more processors to provide an example, executing the firmware, software, routines, instructions, or the like. Alternatively, or in addition to, those skilled in the relevant art(s) will recognize that embodiments of the disclosure described herein may also be implemented as instructions stored on a machine-readable medium, which may be read and executed by one or more processors without departing from the present disclosure. A machine-readable medium may include any mechanism for storing in a form readable by a machine, such as a computing device to provide an example. For example, a machine-readable medium may include read only memory (ROM), random access memory (RAM), magnetic disk storage media, optical storage media, flash memory devices, and the like.

In the exemplary embodiment illustrated in FIG. 1, the temperature measurement system 102 provides a stream of actual temperature data 150 that includes multiple actual temperature values that are related to one or more actual temperatures within the electronic device 100 over time. In some embodiments, the temperature measurement system 102 can provide the stream of actual temperature data 150 at one or more known sensor reading times, namely, at a temperature sampling rate, for example, every two hundred fifty (250) microseconds (μs). As illustrated in FIG. 1, the temperature measurement system 102 can include temperature sensors 110 and a temperature sensor controller 112. In some embodiments, the temperature sensors 110 include one or more temperature sensors, denoted as temperature sensors TS₁ through TSₙ, in FIG. 1, to provide one or more raw temperature sensor readings 152 to the temperature sensor controller 112. In these embodiments, the one or more raw temperature sensor readings 152 can be indicative of one or more actual temperatures of one or more components, such as one or more central processing units (CPUs), one or more graphical processing units (GPUs), one or more neural processing units, one or more motherboards, one or more memory systems, one or more power supply units (PSUs), one or more voltage regulator modules (VRMs), and/or one or more network interface cards (NICs), among others, within the electronic device 100 and/or a host device communicatively coupled to the electronic device 100. In some embodiments, the one or more raw temperature sensor readings 152 can include one or more analog values, for example, one or more voltages and/or currents, that are indicative of the one or more actual temperatures of one or more components within the electronic device 100 and/or the host device. Alternatively, or additionally, the one or more raw temperature sensor readings 152 can include one or more digital values, for example, one or more binary numbers, that are indicative of the one or more actual temperatures of one or more components within the electronic device 100 and/or the host device. In some embodiments, these analog values and/or digital values can based upon, for example, sensor technology, measurement medium, signal processing, wiring and connections, and/or environmental factors, among others, that are associated with the temperature sensors TS₁ through TSₙ. In some embodiments, the temperature sensors TS₁ through TSₙ can include thermocouples, resistance temperature detectors (RTDs), thermistors, and/or infrared sensors, among others. As illustrated in FIG. 1, the temperature sensor controller 112 can access the one or more raw temperature sensor readings 152 provided by the temperature sensors 110 to provide the stream of actual temperature data 150. In some embodiments, the temperature sensor controller 112 can sample, or read, the one or more raw temperature sensor readings 152 provided by the temperature sensors 110 at the temperature sampling rate, for example, every two hundred fifty (250) microseconds (μs), to provide the multiple actual temperature values from among the stream of actual temperature data 150 at the temperature sampling rate. After sampling the one or more raw temperature sensor readings 152, the temperature sensor controller 112 can process, calibrate, and/or interpret, among others, the multiple actual temperature values to generate the stream of actual temperature data 150. In some embodiments, the processing, calibrating, and/or interpreting can include, for example, linearization, filtering, conversion, averaging or smoothing, error handling, among others. After generating the stream of actual temperature data 150, the temperature sensor controller 112 can stream the multiple actual temperature values at the temperature sampling rate to provide the stream of actual temperature data 150 to the performance manager 108.

The workload monitoring system 104 monitors workloads waiting to be executed by the electronic device 100, being performed by the electronic device 100, and/or completed by performed by the electronic device 100. In some embodiments, the one or more workloads refer to the amount of processing, computing, and/or data handling, among others that is expected to be executed by the electronic device 100. The workloads of the electronic device 100 can encompass processes, tasks, operations, demands, threads, or the like that are placed on the resources of the electronic device 100, such as processing power, clock speed, number of cores, and/or cache memory, among others to provide some examples. In some embodiments, the one or more workloads can vary widely, from simple workloads such as word processing, to complex workloads such as video rendering, scientific simulations, and/or database queries, among others. As illustrated in FIG. 1, the workload monitoring system 104 can provide workload data 154 that is indicative of the one or more workloads waiting to be executed by the electronic device 100, the one or more workloads being performed by the electronic device 100, and/or the one or more workloads completed by performed by the electronic device 100. In some embodiments, the workload data 154 can include one or more digital values, for example, one or more binary numbers, that are related to workloads waiting to be executed by the electronic device 100, being performed by the electronic device 100, and/or completed by performed by the electronic device 100. In these embodiments, the workload monitoring system 104 can evaluate one or more performance metrics, such as utilization metrics, throughput metrics, latency metrics, and/or power consumption metrics, among others, to determine the one or more digital values. These performance metrics can be used to effectively characterize the one or more workloads in terms of, for example, the types of instructions, routines, procedures, or the like, the number of instructions, routines, procedures, or the like, the complexity of these instructions, routines, procedures, or the like, the amount of data to process by of these instructions, routines, procedures, or the like, the frequency at which these instructions, routines, procedures, or the like are being requested, and/or the data access patterns needed to execute these instructions, routines, procedures, or the like, among others.

In the exemplary embodiment illustrated in FIG. 1, the temperature measurement system 102 provides a stream of interpolated temperature data 156 that includes multiple interpolated temperature values that are related to one or more predicted temperatures of the electronic device 100 over time. In some embodiments, the temperature measurement system 102 can provide the stream of interpolated temperature data 156 at a temperature interpolation rate, for example, every fifty (50) microseconds (μs). In these embodiments, the temperature interpolation rate can be greater than, or faster than, the temperature sampling rate. For example, the temperature interpolation rate can be an integer multiple of the temperature sampling rate. As illustrated in FIG. 1, the temperature interpolation system 106 can include a power estimator 114, a thermal interpolator 116, and a thermal estimator 118. The power estimator 114 estimates the power needed to execute the one or more workloads indicated by the workload data 154 to provide power consumption data 158. In some embodiments, the power consumption data 158 can include one or more analog values, for example, one or more voltages, currents, and/or powers, that are related to power to be consumed by the electronic device 100 to execute the one or more workloads indicated by the workload data 154. Alternatively, or additionally, the power consumption data 158 can include one or more digital values, for example, one or more binary numbers, that are related to power to be consumed by the electronic device 100 to execute the one or more workloads indicated by the workload data 154. As illustrated in FIG. 1, the power estimator 114 can access the workload data 154 provided by the workload monitoring system 104. In some embodiments, the power estimator 114 can receive the workload data 154 from the workload monitoring system 104. After accessing the workload data 154, the power estimator 114 can estimate the power consumption data 158 based upon the one or more workloads indicated by the workload data 154. In some embodiments, the power estimator 114 can access one or more power consumption models that transform the workload data 154 into a power to be consumed by the electronic device 100 to execute the one or more workloads. In these embodiments, the one or more power consumption models can be developed based upon empirical measurements and/or simulations to map the one or more workloads to the power to be consumed by the electronic device 100 to execute the one or more workloads.

The thermal predictor 116 predicts one or more temperatures of the electronic device 100 to provide one or more temperature predictions 160. In some embodiments, the thermal predictor 116 can be used to model the transient thermal behavior of the electronic device 100. In some embodiments, the thermal predictor 116 can include one or more thermal models for the electronic device 100 that were developed to describe generating, transferring, and/or dissipation of heat within the electronic device 100. In these embodiments, the one or more thermal models of the electronic device 100 can be modeled using a Foster resistance capacitance ladder, a Cauer resistance capacitance ladder, and/or any other suitable resistance capacitance ladder that will be apparent to those skilled in the relevant art(s) without departing from the spirit and scope of the present disclosure. In some embodiments, the thermal predictor 116 can implement the one or more thermal models in hardware, software executing on hardware, and/or any combination thereof. In these embodiments, the thermal predictor 116 can simulate the one or more thermal models in accordance with the power consumption data 158 to provide the one or more temperature predictions 160. In these embodiments, the thermal predictor 116 can apply the power consumption data 158 to the one or more thermal models to predict the one or more temperatures of the electronic device 100 to provide one or more temperature predictions 160. In some embodiments, the one or more temperature predictions 160 can include one or more analog values, for example, one or more voltages and/or currents, that are indicative of the one or more predicted temperatures of one or more components within the electronic device 100 and/or the host device. Alternatively, or additionally, the one or more temperature predictions 160 can include one or more digital values, for example, one or more binary numbers, that are indicative of the one or more actual temperatures of one or more components within the electronic device 100 and/or the host device.

As illustrated in FIG. 1, the thermal interpolator 118 can access the one or more temperature predictions 160 provided by the thermal predictor 116 to provide the stream of interpolated temperature data 156. In some embodiments, the thermal interpolator 118 can sample, or read, the one or more temperature predictions 160 provided by the thermal predictor 116 at the temperature interpolation rate, for example, every fifty (50) microseconds (μs), to provide the multiple interpolated temperature values from among the stream of interpolated temperature data 156 at the temperature interpolation rate. After sampling the one or more temperature predictions 160, the thermal interpolator 118 can process, calibrate, and/or interpret, among others, the multiple predicted temperature values to generate the stream of interpolated temperature data 156. In some embodiments, the processing, calibrating, and/or interpreting can include, for example, linearization, filtering, conversion, averaging or smoothing, error handling, among others. After generating the stream of interpolated temperature data 156, the thermal interpolator 118 can stream the multiple interpolated temperature values at the temperature interpolation rate to provide the stream of interpolated temperature data 156 to the performance manager 108.

The performance manager 108 functionally cooperates with the workload monitoring system 104 to execute the one or more workloads based upon the stream of actual temperature data 150 and the stream of interpolated temperature data 156. In some embodiments, the performance manager 108 can access the stream of actual temperature data 150 at the temperature sampling rate and the stream of interpolated temperature data 156 at the temperature interpolation rate. In these embodiments, the performance manager 108 can receive the stream of actual temperature data 150 from the temperature measurement system 102 at the temperature sampling rate, for example, every two hundred fifty (250) microseconds (μs), and the stream of interpolated temperature data 156 from the temperature interpolation system 106 at the temperature interpolation rate, for example, every fifty (50) microseconds (μs). In these embodiments, the performance manager 108 can receive the multiple actual temperature values from among the stream of actual temperature data 150 at the temperature sampling rate and the multiple interpolated temperature values from among the stream of interpolated temperature data 156 at the temperature interpolation rate. In some embodiments, the performance manager 108 can estimate, or interpolate, one or more temperatures of the electronic device 100 based upon the stream of actual temperature data 150 and the stream of interpolated temperature data 156. In these embodiments, these temperatures of the electronic device 100 estimated by the performance manager 108 can be characterized as being more precise than the actual temperature values from among the stream of actual temperature data 150 having include smaller intervals between these temperatures when compared to the multiple actual temperature values from among the stream of actual temperature data 150. In some embodiments, the performance manager 108 can accumulate, or combine, the stream of actual temperature data 150 and the stream of interpolated temperature data 156 to estimate, or interpolate, the one or more temperatures of the electronic device 100. In these embodiments, the performance manager 108 can accumulate, or combine, the multiple actual temperature values from among the stream of actual temperature data 150 at the temperature sampling rate and the multiple interpolated temperature values from among the stream of interpolated temperature data 156 at the temperature interpolation rate to estimate, or interpolate, the one or more temperatures of the electronic device 100. In some embodiments, the performance manager 108 can include an accumulator to estimate rate to estimate, or interpolate, the one or more temperatures of the electronic device 100. In these embodiments, the performance manager 108 can iteratively load a first actual temperature value from among the stream of actual temperature data 150 received at a first duration in time during the temperature sampling rate into the accumulator to provide a first temperature of the electronic device 100 at the first duration in time, for example, at two hundred fifty (250) microseconds (μs). In these embodiments, the performance manager 108 can iteratively accumulate, or combine, one or more interpolated temperature values from among the stream of interpolated temperature data 156 to the accumulator to provide more temperatures of the electronic device 100 at various durations in time, for example, at three hundred (300) microseconds (μs), three hundred fifty (350) microseconds (μs), four hundred (400) microseconds (μs), and four hundred fifty (450) microseconds (μs). In some embodiments, the performance manager 108 can continue to accumulate, or combine, the one or more interpolated temperature values until receiving a second actual temperature value from among the stream of actual temperature data 150 at a second duration in time, for example, at five hundred (500) microseconds (μs). In these embodiments, the performance manager 108 can iteratively reset the accumulator upon receiving the second actual temperature value.

In some embodiments, the performance manager 108 can access a temperature profile for the electronic device 100 that specifies one or more temperature thresholds for the electronic device 100. In these embodiments, the performance manager 108 can compare the temperature of the electronic device 100 to these temperature thresholds to ensure the electronic device 100 operates safely under various operating conditions, for example, when executing the one or more workloads. In these embodiments, the one or more temperature thresholds represents one or more safe operating temperatures set, for example, by a manufacturer of the electronic device 100, whereby performance degradation, system instability, or even permanent damage can occur if these temperature thresholds are exceeded. In some embodiments, the one or more temperature thresholds can include one or more thermal guard bands that represent one or more safety margins, or allowances, that are included in the temperature profile of the electronic device 100 to ensure that the electronic device 100 operates safely under various operating conditions. In these embodiments, the one or more thermal guard bands include one or more temperature margins that account for uncertainties and variations in temperature, for example, ambient temperature changes, component tolerance, and/or variations in operation conditions, among others, to ensure that the electronic device 100 remains within its temperature limits even under, for example, worst-case scenarios. In some embodiments, the performance manager 108 can execute dynamic voltage and frequency management (DVFM) to configure the workload monitoring system 104 in accordance with the one or more temperatures within the electronic device 100. As part of this DVFM, the performance manager 108 can determine the operating voltages and/or the operating frequencies of the workload monitoring system 104 based upon the temperature of the electronic device 100 during the temperature interpolation rate. In some embodiments, the performance manager 108 can determine the operating voltages and/or the operating frequencies of the workload monitoring system 104 such that the temperature of the electronic device 100 during the temperature interpolation rate does not exceed the one or more temperature thresholds. In these embodiments, the performance manager 108 can cause the operating voltages and/or the operating frequencies of the workload monitoring system 104 to be decreased in response to the temperature of the electronic device 100 during the temperature interpolation rate exceeding the one or more temperature thresholds.

### Exemplary Operations of the Exemplary Electronic Device

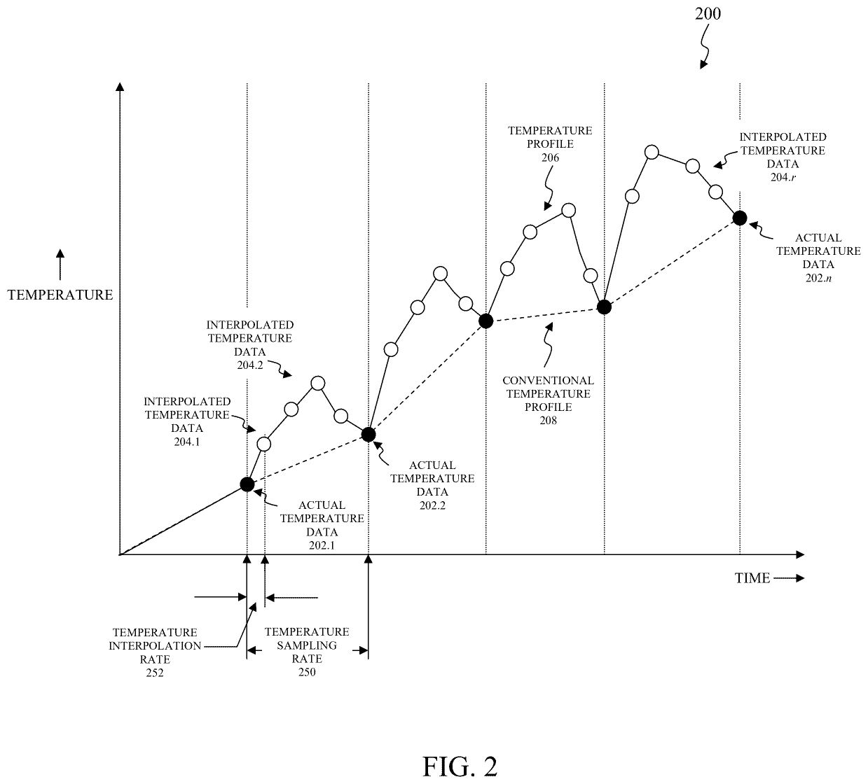

FIG. 2 graphically illustrates a first exemplary operation of the exemplary electronic device in accordance with various embodiments of the present disclosure. The disclosure is not limited to this exemplary operation. Rather, it will be apparent to ordinary persons skilled in the relevant art(s) that other exemplary operations are within the scope and spirit of the present disclosure. The following discussion describes an exemplary operational control flow 200 for estimating, or interpolating, one or more temperatures of an electronic device, such as the electronic device 100 to provide an example, over time.

In the exemplary embodiment illustrated in FIG. 2, the operational control flow 200 can access actual temperature data 202.1 through 202.n at a temperature sampling rate 250, for example, every two hundred fifty (250) microseconds (μs). In some embodiments, the actual temperature data 202.1 through 202.n can represent an exemplary embodiment of the stream of actual temperature data 150. In some embodiments, the operational control flow 200 can sample, or read, one or more raw temperature sensor readings, such as the one or more raw temperature sensor readings 152, at the temperature sampling rate 250, for example, every two hundred fifty (250) microseconds (μs), to provide the actual temperature data 202.1 through 202.n at the temperature sampling rate 250. After sampling the one or more raw temperature sensor readings, the operational control flow 200 can process, calibrate, and/or interpret, among others, the one or more sampled raw temperature sensor readings to generate the actual temperature data 202.1 through 202.n. In some embodiments, the processing, calibrating, and/or interpreting can include, for example, linearization, filtering, conversion, averaging or smoothing, error handling, among others.

In the exemplary embodiment illustrated in FIG. 2, the operational control flow 200 can access interpolated temperature data 204.1 through 204.r at a temperature interpolation rate 252, for example, every fifty (50) microseconds (μs). In some embodiments, the interpolated temperature data 204.1 through 204.r can represent an exemplary embodiment of the stream of interpolated temperature data 156. Although the interpolated temperature data 204.1 through 204.r are illustrated as being greater than, for example, overshooting, the actual temperature data 202.1 through 202.n in FIG. 2, this for exemplary purposes only. Those skilled in the relevant art(s) will recognize that the interpolated temperature data 204.1 through 204.r can being less than, for example, undershooting, the actual temperature data 202.1 through 202.n without departing from the spirit and scope of the present disclosure. In some embodiments, the operational control flow 200 can sample, or read, one or more temperature predictions, such as the one or more temperature predictions 160, for the operational control flow 200 to execute one or more workloads at the temperature interpolation rate 252, for example, every hundred fifty (50) microseconds (μs), to provide the interpolated temperature data 204.1 through 204.r at the temperature interpolation rate 252. After sampling the one or more temperature predictions, the operational control flow 200 can process, calibrate, and/or interpret, among others, the one or more temperature predictions to generate the interpolated temperature data 204.1 through 204.r. In some embodiments, the processing, calibrating, and/or interpreting can include, for example, linearization, filtering, conversion, averaging or smoothing, error handling, among others.

In the exemplary embodiment illustrated in FIG. 2, the operational control flow 200 can estimate, or interpolate, one or more temperatures of the electronic device over time based upon the actual temperature data 202.1 through 202.n and the interpolated temperature data 204.1 through 204.r to develop a temperature profile 206 for the electronic device. In some embodiments, the operational control flow 200 can accumulate, or combine, the actual temperature data 202.1 through 202.n and the interpolated temperature data 204.1 through 204.r to estimate, or interpolate, the one or more temperatures of the electronic device. In these embodiments, the operational control flow 200 can accumulate, or combine, the actual temperature data 202.1 through 202.n at the temperature sampling rate and the multiple interpolated temperature values from among the stream of interpolated temperature data 156 at the temperature interpolation rate to estimate, or interpolate, the one or more temperatures of the electronic device. As illustrated in FIG. 2, the operational control flow 200 can accumulate, or combine, the actual temperature data 202.1 and the interpolated temperature data 204.1 to determine the temperature of the electronic device at a first instance in time, for example, at three hundred (300) microseconds (μs). As additionally illustrated in FIG. 2, the operational control flow 200 can accumulate, or combine, the temperature of the electronic device at the first instance in time and the interpolated temperature data 204.2 to determine the temperature of the electronic device at a second instance in time, for example, at three hundred fifty (350) microseconds (μs). As illustrated in FIG. 2, the temperature profile 206 developed by the operational control flow 200 beneficially includes more precise temperature values allowing for a more detailed analysis of the temperature of the electronic device when compared to a conventional temperature profile 208. In some embodiments, these more precise temperature values can advantageously capture transient variations in the temperature profile 206 occurring between the readings of the one or more temperature sensors which are otherwise hidden in the conventional temperature profile 208 that was developed solely from these readings alone.

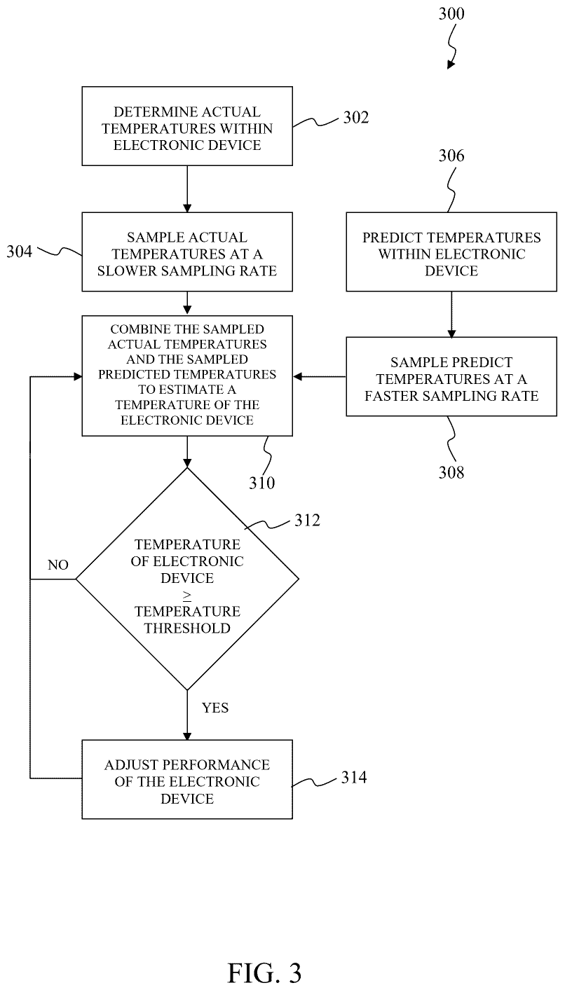

FIG. 3 illustrates a flowchart of a second exemplary operation of the exemplary electronic device in accordance with various embodiments of the present disclosure. The disclosure is not limited to this operational description. Rather, it will be apparent to ordinary persons skilled in the relevant art(s) that other operational control flows are within the scope and spirit of the present disclosure. The following discussion describes an exemplary operational control flow 300 for estimating, or interpolating, a temperature of an electronic device, such as the electronic device 100 to provide an example.

At operation 302, the operational control flow 300 determines one or more actual temperature values within the electronic device. In some embodiments, the operational control flow 300 can determine the one or more actual temperature values within the electronic device that have been provided by one or more temperature sensors as described herein. In these embodiments, the one or more actual temperature values can include one or more analog values, for example, one or more voltages and/or currents, that are indicative of one or actual temperatures within the electronic device. Alternatively, or additionally, the one or more actual temperature values can include one or more digital values, for example, one or more binary numbers, which are indicative of one or more actual temperature within the electronic device. In some embodiments, the one or more actual temperature values can represent an exemplary embodiment of the one or more raw temperature sensor readings 152.

At operation 304, the operational control flow 300 samples the one or more actual temperature values from operation 302 at a slower sampling rate. In some embodiments, the operational control flow 300 can sample, or read, the one or more actual temperature values from operation 302 at the temperature sampling rate, for example, every two hundred fifty (250) microseconds (μs), to provide a stream of actual temperature data, such as the stream of actual temperature data 150 to provide an example, at the temperature sampling rate. After sampling the one or more actual temperature values from operation 302, the operational control flow 300 can process, calibrate, and/or interpret, among others, the one or more actual temperature values from operation 302 to generate the stream of actual temperature data. In some embodiments, the processing, calibrating, and/or interpreting can include, for example, linearization, filtering, conversion, averaging or smoothing, error handling, among others. After generating the stream of actual temperature data, the operational control flow 300 can stream the one or more actual temperature values from operation 302 at the temperature sampling rate to provide the stream of actual temperature data.

At operation 306, the operational control flow 300 predicts one or more temperature values within the electronic device. In some embodiments, the operational control flow 300 can predict the one or more predicted temperature values within the electronic device from one or more thermal models of the electronic device, for example, a Foster resistance capacitance ladder, a Cauer resistance capacitance ladder, and/or any other suitable resistance capacitance ladder that will be apparent to those skilled in the relevant art(s) without departing from the spirit and scope of the present disclosure, as described herein. In these embodiments, the one or more predicted temperature values can include one or more analog values, for example, one or more voltages and/or currents, which are indicative of one or interpolated temperatures within the electronic device. Alternatively, or additionally, the one or more predicted temperature values can include one or more digital values, for example, one or more binary numbers, that are indicative of one or more predicted temperature values within the electronic device. In some embodiments, the one or more predicted temperature values can represent an exemplary embodiment of the one or more temperature predictions 160.

At operation 308, the operational control flow 300 samples the one or more predicted temperature values from operation 306 at a faster sampling rate. In some embodiments, the faster sampling rate can be described as being greater than, or faster than, the slower sampling rate from operation 304. In some embodiments, the operational control flow 300 can sample, or read, the one or more predicted temperature values from operation 306 at the temperature interpolation rate, for example, every fifty (50) microseconds (μs), to provide a stream of interpolated temperature data, such as the stream of interpolated temperature data 156 to provide an example, at the temperature interpolation rate. After sampling the one or more predicted temperature values from operation 306, the operational control flow 300 can process, calibrate, and/or interpret, among others, the one or more predicted temperature values from operation 306 to generate the stream of interpolated temperature data. In some embodiments, the processing, calibrating, and/or interpreting can include, for example, linearization, filtering, conversion, averaging or smoothing, error handling, among others. After generating the stream of interpolated temperature data, the operational control flow 300 can stream the one or more predicted temperature values from operation 306 at the temperature interpolation rate to provide the stream of interpolated temperature data.

At operation 310, the operational control flow 300 combines the sampled one or more actual temperature values from operation 302 at the slower rate and the sampled one or more predicted temperature values from operation 306 at the faster rate to estimate the temperature of the electronic device at the faster rate from operation 308. In some embodiments, the operational control flow 300 can accumulate, or combine, the stream of actual temperature data and the stream of interpolated temperature data to estimate, or interpolate, the temperature of the electronic device. In these embodiments, the operational control flow 300 can accumulate, or combine, the one or more actual temperature values from operation 302 at the slower sampling rate and the one or more predicted temperature values from operation 306 at the faster sampling rate to estimate, or interpolate, the temperature of the electronic device at the faster sampling rate from operation 308 as described herein.

At operation 312, the operational control flow 300 compares the temperature of the electronic device from operation 310 to a temperature threshold. In some embodiments, the operational control flow 300 can access a temperature profile for the electronic device that specifies the temperature threshold for the electronic device. In these embodiments, the operational control flow 300 can compare the temperature of the electronic device from operation 310 to the temperature threshold to ensure the electronic device operates safely under various operating conditions as described herein. The operational control flow 300 reverts to operation 310 when the temperature of the electronic device from operation 310 is less than or equal to the temperature threshold. Otherwise, the proceeds to operation 314 when the temperature of the electronic device from operation 310 is greater than the temperature threshold.

At operation 314, the operational control flow 300 adjusts the performance of the electronic device. In some embodiments, the operational control flow 300 adjusts performance of the electronic device when the temperature of the electronic device from operation 310 is greater than the temperature threshold from operation 312. In some embodiments, the operational control flow 300 can execute dynamic voltage and frequency management (DVFM) to configure the electronic device as described herein. As part of this DVFM, the operational control flow 300 can determine the operating voltages and/or the operating frequencies of the electronic device based upon the temperature of the electronic device from operation 310. In some embodiments, the operational control flow 300 can determine the operating voltages and/or the operating frequencies of the workload monitoring system 104 such that the temperature of the electronic device from operation 310 does not exceed the temperature threshold. In these embodiments, the operational control flow 300 can reduce the operating voltages and/or the operating frequencies of the electronic device in response to the temperature of the electronic device from operation 310 being greater than the temperature threshold from operation 312.

Exemplary Thermal Predictor that can be Implemented within the Exemplary Electronic Device

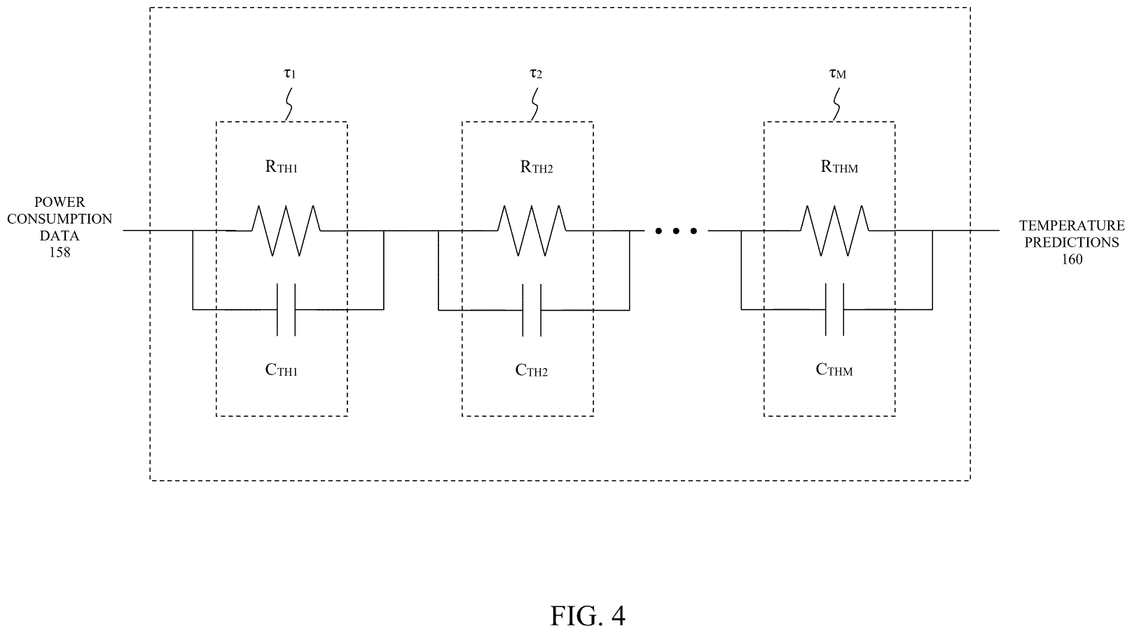

FIG. 4 graphically illustrates an exemplary thermal predictor that can be implemented within the exemplary electronic device in accordance with various embodiments of the present disclosure. In the exemplary embodiment illustrated in FIG. 4, a thermal predictor 400 can predicts one or more temperatures of an electronic device, such as the electronic device 100 to provide an example, based upon the power consumption data 158 to provide the one or more temperature predictions 160 as described herein. In some embodiments, the thermal predictor 116 can be implemented using a Foster resistance capacitance ladder that describes the generating, the transferring, and/or the dissipation of heat within the electronic device 100. As to be described in further detail below, the Foster resistance capacitance ladder can be used to model the transient thermal behavior of the electronic device, for example, predict the temperature change of the electronic device 100 over time. In some embodiments, the Foster resistance capacitance ladder can model the generating, transferring, and/or dissipation of heat within the electronic device 100. In some embodiments, the thermal predictor 400 can represent an exemplary embodiment of the thermal predictor 116.

As illustrated in FIG. 4, the Foster resistance capacitance ladder includes thermal resistances R_{THI} through R_{THM} and thermal capacitances C_{THI} through C_{THM}. In some embodiments, each thermal resistance from among the R_{THI} thermal resistances R_{THI} through R_{THM} is connected in parallel with a corresponding thermal capacitance from among the thermal capacitances C_{THI} through C_{THM} to provide a corresponding thermal time constant from among thermal time constants τ_{I} through τ_{M}. In some embodiments, the thermal resistances R_{THI} through R_{THM} represent the resistance to heat flow within the electronic device and/or the thermal capacitances C_{THI} through C_{THM} represent the capacity of the electronic device to store heat. In some embodiments, the identification of the thermal resistances R_{THI} through R_{THM} and the thermal capacitances C_{THI} through C_{THM} to model the transient thermal behavior of the electronic device is well known and will not be discussed in further detail. Generally speaking, the thermal resistances R_{THI} through R_{THM} and the thermal capacitances C_{THI} through C_{THM} can be identified through a process of thermal characterization and fitting to experimental or simulated data. This process can include experimental measurement of the thermal response of the electronic device to a known power input, thermal simulation using for example, finite element analysis (FEA), to generate a thermal response curve for the electronic device, and/or estimation of the thermal time constants τ_{I} through τ_{M} using for example, Least Squares Fitting to provide an example, to fit the thermal response of the electronic device 100 within the thermal response curve.

In some embodiments, the number of thermal resistances within the thermal resistances R_{THI} through R_{THM} and the number of thermal capacitances within the thermal capacitances C_{THI} through C_{THM} can determine the accuracy of the Foster resistance capacitance ladder in predicting the temperature change of the electronic device 100 over time. However, more thermal resistances within the thermal resistances R_{THI} through R_{THM} and more thermal capacitances within the thermal capacitances C_{THI} through C_{THM} can increase the computational complexity of the Foster resistance capacitance ladder. As such, in some embodiments, the complexity of the Foster resistance capacitance ladder can be balanced with the accuracy of the Foster resistance capacitance ladder in predicting the temperature change of the electronic device 100 over time. In some embodiments, this balancing can be related to the temperature interpolation rate, for example, every fifty (50) microseconds (μs). In these embodiments, the Foster resistance capacitance ladder can exclude those thermal time constants from among thermal time constants τ_{I} through τ_{M} that a less than a thermal approximation threshold. In these embodiments, the thermal approximation threshold can be proportional to the temperature interpolation rate, for example, approximately seventy (70) percent, seventy-five (75) percent, eighty (80) percent, among others, of the temperature interpolation rate, to approximate the Foster resistance capacitance ladder.

Exemplary Computer System that can be Used to Implement the Exemplary Electronic Device

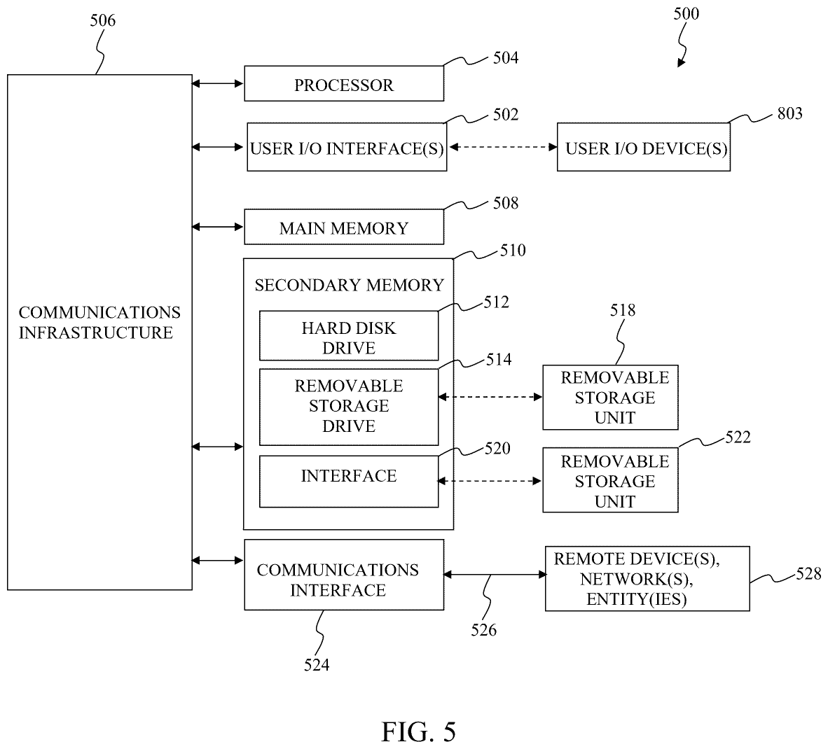

FIG. 5 illustrates a block diagram of an exemplary computer system that can be used to implement the exemplary electronic device in accordance with various embodiments of the present disclosure. Computer system 500 can be any well-known computer capable of performing the functions described herein. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

### Conclusion

Embodiments of the disclosure can be implemented in hardware, firmware, software application, or any combination thereof. Embodiments of the disclosure can also be implemented as instructions stored on one or more computer-readable mediums, which can be read and executed by one or more processors. A computer-readable medium can include any mechanism for storing or transmitting information in a form readable by a computer (e.g., a computing circuitry). For example, a computer-readable medium can include non-transitory computer-readable mediums such as read only memory (ROM); random access memory (RAM); magnetic disk storage media; optical storage media; flash memory devices; and others. As another example, the computer-readable medium can include transitory computer-readable medium such as electrical, optical, acoustical, or other forms of propagated signals (e.g., carrier waves, infrared signals, digital signals, etc.). Further, firmware, software application, routines, instructions have been described as executing certain actions. However, it should be appreciated that such descriptions are merely for convenience and that such actions in fact result from computing devices, processors, controllers, or other devices executing the firmware, software application, routines, instructions, etc.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately executed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan considering the teachings and guidance.

The breadth and scope of the disclosure should not be limited by any of the above-described exemplary embodiments but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. An electronic device, comprising:
a temperature measurement system configured to sample a raw temperature sensor reading provided by a temperature sensor at a temperature sampling rate to provide a plurality of actual temperature values;
a temperature interpolation system configured to sample a temperature prediction that has been predicted by the electronic device at a temperature interpolation rate to provide a plurality of interpolated temperature values, the temperature interpolation rate being greater than the temperature sampling rate; and
a performance manager configured to:
combine the plurality of actual temperature values at the temperature sampling rate and the plurality of interpolated temperature values at the temperature interpolation rate to estimate a plurality of temperatures of the electronic device at the temperature interpolation rate,
compare the plurality of temperatures of the electronic device at the temperature interpolation rate to a temperature threshold, and
adjust performance of the electronic device when one or more of the plurality of temperatures of the electronic device at the temperature interpolation rate is greater than the temperature threshold.

2. The electronic device of claim 1, wherein the temperature interpolation system is further configured to predict the plurality of interpolated temperature values at the temperature interpolation rate based upon power needed to execute a workload.

3. The electronic device of claim 2, wherein the temperature interpolation system is further configured to:
develop a thermal model of the electronic device to model transient thermal behavior of the electronic device; and
simulate the thermal model of the electronic device in accordance with the power needed to execute the workload to provide the temperature prediction.

4. The electronic device of claim 3, wherein the thermal model of the electronic device comprises a Foster resistance capacitance ladder having a plurality of thermal time constants, the plurality of thermal time constants being less than a percentage of the temperature interpolation rate.

5. The electronic device of claim 1, wherein the performance manager is further configured to:
load a first actual temperature value from among the plurality of actual temperature values received at a first duration in time to provide a first temperature of the electronic device at the first duration in time; and
combine a plurality of second interpolated temperature values from among the plurality of interpolated temperature values received at a plurality of second durations in time and the first actual temperature value to provide a plurality of second temperatures of the electronic device at the plurality of second durations in time.

6. The electronic device of claim 5, wherein the performance manager comprises an accumulator, and
wherein the performance manager is configured to:
load the first actual temperature value into the accumulator; and
reset the accumulator upon receiving a third actual temperature value from among the plurality of actual temperature values received at a third duration in time.

7. A method for estimating a plurality of temperatures of an electronic device, the method comprising:
sampling, by the electronic device at a temperature sampling rate, a raw temperature sensor reading provided by a temperature sensor to provide a plurality of actual temperature values;
sampling, by the electronic device at a temperature interpolation rate, a temperature prediction that has been predicted by the electronic device to provide a plurality of interpolated temperature values, the temperature interpolation rate being greater than the temperature sampling rate; and
combining, by the electronic device, the plurality of actual temperature values at the temperature sampling rate and the plurality of interpolated temperature values at the temperature interpolation rate to estimate the plurality of temperatures of the electronic device at the temperature interpolation rate.

8. The method of claim 7, further comprising predicting, by the electronic device, the plurality of interpolated temperature values at the temperature interpolation rate based upon power needed to execute a workload.

9. The method of claim 8, wherein the predicting comprises:
developing, by the electronic device, a thermal model of the electronic device to model transient thermal behavior of the electronic device; and
simulating, by the electronic device, the thermal model of the electronic device in accordance with the power needed to execute a workload to provide the temperature prediction.

10. The method of claim 9, wherein the thermal model of the electronic device comprises a Foster resistance capacitance ladder having a plurality of thermal time constants, the plurality of thermal time constants being less than a percentage of the temperature interpolation rate.

11. The method of claim 8, further comprising:
accessing workload data that is indicative of the workload waiting to be executed by the electronic device, the workload being performed by the electronic device, or the workload completed by the electronic device; and
evaluating one or more performance metrics in accordance with the workload data to determine the power needed to execute the workload.

12. The method of claim 7, wherein the combining comprises:
loading, by the electronic device, a first actual temperature value from among the plurality of actual temperature values received at a first duration in time to provide a first temperature of the electronic device at the first duration in time; and
combining, by the electronic device, a plurality of second interpolated temperature values from among the plurality of interpolated temperature values received at a plurality of second durations in time and the first actual temperature value to provide a plurality of second temperatures of the electronic device at the plurality of second durations in time.

13. The method of claim 12, wherein the loading comprising:
loading the first actual temperature value into an accumulator, and
wherein the method further comprises resetting the accumulator upon receiving a third actual temperature value from among the plurality of actual temperature values received at a third duration in time.

14. An electronic device, comprising:
a memory configured to store instructions; and
a processor configured to execute the instructions stored in the memory, the instructions, when executed by the processor, configuring the processor to:
sample a raw temperature sensor reading provided by a temperature sensor at a temperature sampling rate to provide a plurality of actual temperature values,
sample a temperature prediction that has been predicted by the electronic device at a temperature interpolation rate to provide a plurality of interpolated temperature values, the temperature interpolation rate being greater than the temperature sampling rate, and
combine the plurality of actual temperature values at the temperature sampling rate and the plurality of interpolated temperature values at the temperature interpolation rate to estimate a plurality of temperatures of the electronic device at the temperature interpolation rate.

15. The electronic device of claim 14, wherein the instructions, when executed by the processor, further configure the processor to predict the plurality of interpolated temperature values at the temperature interpolation rate based upon power needed to execute a workload.

16. The electronic device of claim 14, wherein the instructions, when executed by the processor, further configure the processor to:
develop a thermal model of the electronic device to model transient thermal behavior of the electronic device; and
simulate the thermal model of the electronic device in accordance with the power needed to execute a workload to provide the temperature prediction.

17. The electronic device of claim 16, wherein the thermal model of the electronic device comprises a Foster resistance capacitance ladder having a plurality of thermal time constants, the plurality of thermal time constants being less than a percentage of the temperature interpolation rate.

18. The electronic device of claim 15, wherein the instructions, when executed by the processor, further configure the processor to:
access workload data that is indicative of the workload waiting to be executed by the electronic device, the workload being performed by the electronic device, or the workload completed by the electronic device; and
evaluate one or more performance metrics in accordance with the workload data to determine the power needed to execute the workload.

19. The electronic device of claim 14, wherein the instructions, when executed by the processor, configure the processor to:
load a first actual temperature value from among the plurality of actual temperature values received at a first duration in time to provide a first temperature of the electronic device at the first duration in time; and
combine a plurality of second interpolated temperature values from among the plurality of interpolated temperature values received at a plurality of second durations in time and the first actual temperature value to provide a plurality of second temperatures of the electronic device at the plurality of second durations in time.

20. The electronic device of claim 19, wherein the instructions, when executed by the processor, further configure the processor to:
load the first actual temperature value into an accumulator; and
reset the accumulator upon receiving a third actual temperature value from among the plurality of actual temperature values received at a third duration in time.
